(19) United States
(12) Patent Application Publication
(10) Pub. No.: US 2025/0051867 A1
(43) Pub. Date: Feb. 13, 2025

(54) GRAIN ORIENTED ELECTRICAL STEEL SHEET AND METHOD FOR MANUFACTURING SAME

(71) Applicant: POSCO CO., LTD, Gyeongsangbuk-do, Pohang-si (KR)

(72) Inventors: Jae-Song Kim, Pohang-si, Gyeongsangbuk-do (KR); Il-Nam Yang, Pohang-si, Gyeongsangbuk-do (KR); Seonghoon Min, Pohang-si, Gyeongsangbuk-do (KR)

(73) Assignee: POSCO CO., LTD, Gyeongsangbuk-do, Pohang-si (KR)

(21) Appl. No.: 18/721,633

(22) PCT Filed: Dec. 21, 2022
(86) PCT No.: PCT/KR2022/020914

§ 371 Date: Jun. 18, 2024

(30) Foreign Application Priority Data
Dec. 22, 2021 (KR) 10-2021-0184719

(51) Int. Cl. C21D 8/02; C21D 1/26; C21D 3/04; C21D 9/46; C21D 10/00; C22C 38/00; C22C 38/04; C22C 38/06; C22C 38/34; C23C 30/00

(52) U.S. Cl. CPC C21D 8/0205; C21D 1/26; C21D 3/04; C21D 8/0226; C21D 8/0236; C21D 9/46; C21D 10/005; C22C 38/004; C22C 38/04; C22C 38/06; C22C 38/34; C23C 30/005; C21D 2201/05

(57) ABSTRACT

A grain oriented electrical steel sheet according to an exemplary embodiment of the present invention includes a grain oriented electrical steel sheet base material and a metal oxide layer present on both sides of the grain oriented electrical steel sheet base material. A maximum Al fraction in the metal oxide layer is 0.15 to 1.0 wt %, and a ratio (DW_{L}/DW_{S}) of an average magnetic domain width (DW_{L}) of a side with a large average magnetic domain width to an average magnetic domain width (DW_{S}) of a side with a small average magnetic domain width of one side and the other side of the electrical steel sheet base material is 1.2 to 1.8.

### TECHNICAL FIELD

An exemplary embodiment of the present invention relates to a grain oriented electrical steel sheet and a method for manufacturing the same. Specifically, the present invention relates to a grain oriented electrical steel sheet in which core loss and excitation power are simultaneously improved by adjusting a maximum Al content in a metal oxide layer present between an insulating coating and a base iron and adjusting a magnetic domain width ratio on both sides of the steel sheet, and a method for manufacturing the grain oriented electrical steel sheet.

### BACKGROUND ART

A grain oriented electrical steel sheet is used as an iron core of transformers, and in general, is recently required to have improved excitation power related to no-load current, in addition to iron loss and magnetic flux density characteristics. The iron loss is a characteristic that directly affects the efficiency of the transformer and is a main characteristic that divides the grades of grain oriented electrical steel sheets. The magnetic flux density is a characteristic that determines copper loss and a size of the transformer.

In order to improve the above characteristics, an integration degree of {110}<001> Goss texture should be increased in the finally manufactured grain oriented electrical steel sheet. In order to create the Goss texture, complicated processes such as component control in steelmaking, reheating of a slab and controlling of hot rolling processing factors in hot rolling, an annealing heat treatment of a hot rolled sheet, a primary recrystallization annealing, and a secondary recrystallization annealing are required, and these processes should be managed very precisely and strictly. Excellent grain oriented electrical steel products resultantly manufactured have an integration degree of the Goss texture of less than 3 degrees and usually have coarse grains of several millimeters to several centimeters. When the grain size is coarse, the width of the magnetic domain becomes wider, and the speed of the domain walls increases, increasing an abnormal eddy current loss. In order to reduce the abnormal eddy current loss, various methods of refining a magnetic domain using laser, plasma, electron beam and the like are used. These methods reduce the size of the magnetic domain by forming stimulation energy with local residual stress, so despite the increase in hysteresis loss, the abnormal eddy current loss is reduced, resulting in improvement in overall iron loss.

However, the local residual stress limits the mobility itself of the magnetic domain wall, which leads to a decrease in permeability, thereby deteriorating the excitation power closely related to permeability. If the excitation power deteriorates, no-load current of the transformer increases, which places a burden on a transformer power system, requiring additional electrical components or a design change. Therefore, there is a need for a plan to improve iron loss in consideration of the excitation power.

To solve this problem, a method of improving a magnetic flux density or permeability by optimizing magnetic domain refinement conditions, especially a magnetic domain line spacing depending on a content of Cr in steel has been suggested. In addition, a method of improving permeability in an excitation field (H field) in the region of several A/m by optimizing a laser output has been suggested. In addition, a method of optimizing a magnetic flux density by optimizing a size and a wavelength of the laser or a method of optimizing a magnetic domain condition according to adhesiveness has been suggested.

However, while the above method was able to improve the permeability at an H value of 800 A/m or a few A/m, it was not enough to improve the permeability in the region of tens of A/m, which affects the typical transformer no-load current, and the resulting excitation power.

### DISCLOSURE

### Technical Problem

An exemplary embodiment of the present invention attempts to provide a grain oriented electrical steel sheet and a method for manufacturing the same. Specifically, the present invention is to provide a grain oriented electrical steel sheet in which core loss and excitation power are simultaneously improved by adjusting an oxidation amount of a primary recrystallization annealed plate to control a maximum Al fraction in a metal oxide layer of a final product plate and adjusting a magnetic domain width ratio on both sides of the steel sheet, and a method for manufacturing the grain oriented electrical steel sheet.

### Technical Solution

A grain oriented electrical steel sheet according to an exemplary embodiment of the present invention includes a grain oriented electrical steel sheet base material and a metal oxide layer present on both sides of the grain oriented electrical steel sheet base material, wherein a maximum Al fraction in the metal oxide layer is 0.15 to 1.0 wt %.

Here, the maximum Al fraction refers to an Al content value at a point where an Al content is the highest when measuring the Al content in a thickness direction of the metal oxide layer.

A ratio (DW_{L}/DW_{S}) of an average magnetic domain width (DW_{L}) of a side with a large average magnetic domain width to an average magnetic domain width (DW_{S}) of a side with a small average magnetic domain width of one side and the other side of the electrical steel sheet base material is 1.2 to 1.8.

A thickness of the metal oxide layer 130 may be 1.5 μm to 4 μm.

The grain oriented electrical steel sheet base material may include 2.5 to 4.0 wt % of Si, 0.020 to 0.040 wt % of Al, 0.20 wt % or less of Mn, 0.0060 wt % or less of N, 0.005 wt % or less of C, and 0.0055 wt % or less of S, a balance of Fe, and unavoidable impurities.

The grain oriented electrical steel sheet base material may further include one or more of P: 0.02 to 0.075 wt % and Cr: 0.05 to 0.35 wt %.

The grain oriented electrical steel sheet may further include an insulating coating present on the metal oxide layer.

The magnetic domain width ratio (DW_{L}/DW_{S}) is within a range of 0.23×C_{Al, Max}+1.0 to 0.23×C_{Al, Max}+1.8 when the maximum Al fraction (wt %) in the metal oxide layer is expressed as C_{Al, Max}.

A heat-affected zone may be present in only one of one side and the other side of the electrical steel sheet.

The heat-affected zone may have a line shape extending in a direction intersecting a rolling direction.

The heat-affected zone may be present in plural, and an average spacing between the heat-affected zones may be 3 to 7 mm.

A method for manufacturing a grain oriented electrical steel sheet according to an exemplary embodiment of the present invention includes manufacturing a hot-rolled steel sheet by hot-rolling a slab; manufacturing a cold-rolled steel sheet by cold-rolling the hot-rolled steel sheet; subjecting the cold-rolled steel sheet to primary recrystallization annealing; subjecting the primary recrystallization annealed steel sheet to secondary recrystallization annealing; and performing a magnetic domain refinement treatment on one side of the secondary recrystallization annealed steel sheet.

In the primary recrystallization annealing, a dew point of an atmosphere may be 69 to 72.5° C., and in the magnetic domain refinement treatment, an input energy may be 6.5 to 10 J/m.

The primary recrystallization annealed steel sheet may have an oxygen content of 800 to 1100 ppm.

The oxygen content in the primary recrystallization annealed steel sheet and the input energy can satisfy Formula 2 below.

$$35.8 \times oxygen content ( wt \% ) + 2.5 \leq input energy ( J / m ) \leq 35.8 \times oxygen content ( wt \% ) + 7 \qquad [ Formula 2 ]$$

In the magnetic domain refinement treatment, laser may be irradiated to the steel sheet, a beam length of the laser in a direction perpendicular to a steel sheet rolling direction may be 5 to 15 mm, and a beam width in the steel sheet rolling direction may be 10 to 200 μm.

### Advantageous Effects

According to an exemplary embodiment of the present invention, it is possible to minimize the heat-affected zone that interferes with magnetic domain movement, maximize iron loss reduction, and simultaneously improve excitation power and permeability.

### DESCRIPTION OF THE DRAWINGS

FIG. 1 is a schematic diagram schematically showing a cross section of a grain oriented electrical steel sheet according to an exemplary embodiment of the present invention.

FIG. 2 is a schematic view schematically showing a cross section of a grain oriented electrical steel sheet according to an exemplary embodiment of the present invention.

FIG. 3 is a view schematically showing a surface of a grain oriented electrical steel sheet according to an exemplary embodiment of the present invention.

### MODE FOR INVENTION

The terms such as first, second and third are used for describing, but are not limited to, various parts, components, regions, layers, and/or sections. These terms are used only to discriminate one part, component, region, layer or section from another part, component, region, layer or section. Therefore, a first part, component, region, layer or section described below may be referred to as a second part, component, region, layer or section without departing from the scope of the present invention.

The technical terms used herein are set forth only to mention specific exemplary embodiments and are not intended to limit the present invention. Singular forms used herein are intended to include the plural forms as long as phrases do not clearly indicate an opposite meaning. In the present specification, the term “including” is intended to embody specific characteristics, regions, integers, steps, operations, elements and/or components, but is not intended to exclude presence or addition of other characteristics, regions, integers, steps, operations, elements, and/or components.

When a part is referred to as being “above” or “on” another part, it may be directly above or on the other part or an intervening part may also be present. In contrast, when a part is referred to as being “directly above” another part, there is no intervening part present.

Unless otherwise defined, all terms including technical and scientific terms used herein have the same meanings as the meanings generally understood by one skilled in the art to which the present invention pertains. Terms, such as those defined in commonly used dictionaries, are to be interpreted as having meanings consistent with the relevant technical literature and the present disclosure, and are not to be interpreted as having idealized or overly formal meanings unless expressly so defined herein.

Hereinafter, an exemplary embodiment of the present invention will be described in detail so that one skilled in the art to which the present invention pertains can easily implement the present invention. As those skilled in the art would realize, the described embodiments may be modified in various different ways, all without departing from the spirit or scope of the present invention.

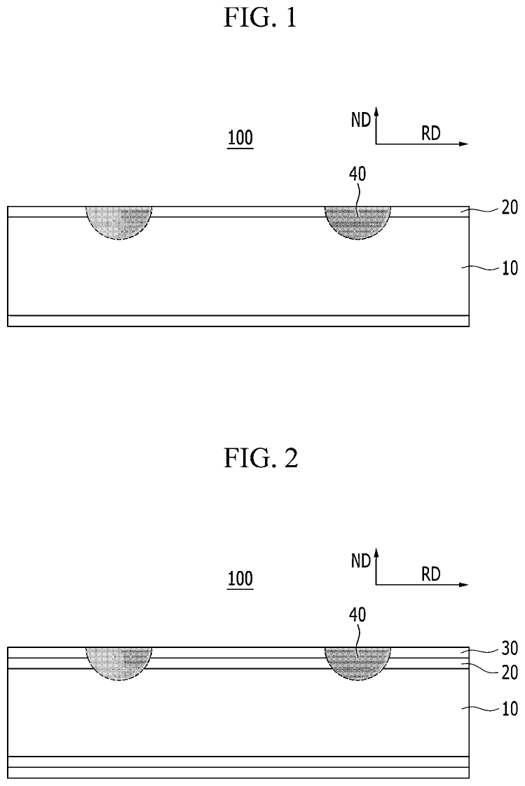

FIGS. 1 and 2 show a schematic diagram of a grain oriented electrical steel sheet 100 according to an exemplary embodiment of the present invention.

As shown in FIG. 1, the grain oriented electrical steel sheet 100 according to an exemplary embodiment of the present invention includes a grain oriented electrical steel sheet base material 10 and a metal oxide layer 20 present on both sides of the grain oriented electrical steel sheet base material 10.

In an exemplary embodiment of the present invention, a maximum Al fraction of the metal oxide layer 20 is adjusted, and at the same time, a ratio (DW_{L}/DW_{S}) of an average magnetic domain width (DW_{L}) of a side with a large average magnetic domain width to an average magnetic domain width (DW_{S}) of a side with a small average magnetic domain width of one side and the other side of the electrical steel sheet base material 10 is adjusted to 1.2 to 1.8.

The maximum Al fraction of the metal oxide layer 20 contributes to improving heat resistance and adhesiveness of the metal oxide layer 20. The maximum Al fraction of the metal oxide layer 20 is 0.15 to 1.0 wt %. Here, the maximum Al fraction refers to an Al content value at a point where an Al content is the highest when measuring the Al content in a thickness direction of the metal oxide layer. More specifically, when the metal oxide layer 20 is analyzed by GDS (Glow Discharge Spectroscopy) along the thickness direction, the maximum Al fraction refers to the largest Al content value among Al content values measured.

If the maximum Al fraction of the metal oxide layer 20 deviates from the lower limit, movement of elements such as C, N, and O is inhibited, so that formation of a metal oxide layer is suppressed and formation of a solid metal oxide layer is prevented, resulting in surface defects. If the maximum Al fraction of the metal oxide layer 20 exceeds the upper limit, the bonding force between oxides may be weakened and surface defects may occur. More specifically, the durability of the metal oxide layer 20 becomes weak, which not only causes surface defects but also weakens the tension action of an insulating coating and a base iron during laser irradiation.

In addition, a ratio (DW_{L}/DW_{S}) of an average magnetic domain width (DW_{L}) of a side with a large average magnetic domain width to an average magnetic domain width (DW_{S}) of a side with a small average magnetic domain width of one side and the other side of the electrical steel sheet base material 10 is adjusted to 1.2 to 1.8. In an exemplary embodiment of the present invention, the magnetic domain may be refined by forming a heat-affected zone 40 in only one of one side or the other side, and accordingly, the average magnetic domain widths of the one side and the other side may be different. Note that when performing magnetic domain refinement, laser, plasma, or an electron beam may be used. In this case, the heat-affected zone 40 may be formed by irradiating the laser, plasma, or electron beam to only one of the one side and the other side. When the input energy for forming the heat-affected zone 40 increases, magnetic domain refinement clearly progresses on the opposite side, thereby lowering the iron loss. However, if the input energy is too high, the heat-affected zone 40 increases due to the magnetic domain refinement, and iron loss rather increases. From a standpoint of excitation power or permeability, the heat-affected zone 40 needs to be minimized because it interferes with magnetic domain movement. In an exemplary embodiment of the present invention, in order to minimize iron loss and simultaneously improve excitation power or permeability, the input energy for forming the heat-affected zone 40 and the magnetic domain width ratio (DW_{L}/DW_{S}) through the input energy are derived. In an exemplary embodiment of the present invention, when the magnetic domain width ratio (DW_{L}/DW_{S}) is 1.2 to 1.8, a deterioration rate of iron loss is low and the excitation power can be stably obtained at a low value. More specifically, the ratio (DW_{L}/DW_{S}) of magnetic domain widths may be 1.25 to 1.75.

In an exemplary embodiment of the present invention, a method of measuring the magnetic domain width is not particularly limited, and the magnetic domain width may be measured by using a Bitter method to photograph magnetic domain patterns on irradiated and non-irradiated surfaces and obtain an average magnetic domain width over the entire measurement surface. For measurement accuracy, an area of a specimen may be 50 mm×50 mm or greater.

A relationship between the maximum Al fraction of the metal oxide layer 20 and the magnetic domain width ratio (DW_{L}/DW_{S}) can satisfy Formula 1 below.

$$0.23 \times {C}_{Al , Max} + 1. \leq {DW}_{L} / {DW}_{S} \leq 0.23 \times {C}_{Al , Max} + 1.8 \qquad [ Formula 1 ]$$

In Formula 1, CAl, Max refers to the maximum Al fraction (wt %) in the metal oxide layer.

The metal oxide layer 20 is also called a base coating layer or a glass coating layer, and is generated while an oxide film generated during a primary recrystallization annealing process and components in an annealing separator react during a secondary recrystallization annealing process. The metal oxide layer 20 may include one or more metals of Mg and Mn in addition to the above-described Al. More specifically, when MgO is used as a main component of the annealing separator, the metal oxide layer 20 may include Mg, and Mg may combine with Si and O to be present in the form of forsterite (Mg₂SiO₄). Al in the metal oxide layer is present in a spinel state, and due to the structural difference from forsterite, if the amount of Al in the spinel state increases, it is difficult to maintain adhesiveness between the insulating coating and the base iron, so it is advantageous to reduce the magnetic domain width ratio by reducing the laser irradiation intensity.

The metal oxide layer 20 may have a thickness of 1.5 to 4 μm. If the thickness of the metal oxide layer 20 is too thin, a large amount of heat-affected zones 40 is generated, and the ratio of magnetic domain width (DW_{L}/DW_{S}) decreases, which may ultimately adversely affect the excitation power and the permeability. On the other hand, if the thickness of the metal oxide layer 20 is too thick, the heat-affected zone 40 may not be properly formed in the steel sheet base material 10, which may adversely affect iron loss. More specifically, the metal oxide layer 20 may have a thickness of 1.7 to 3.7 μm.

The grain oriented electrical steel sheet base material 10 includes 2.5 to 4.0 wt % of Si, 0.020 to 0.040 wt % of Al, 0.20 wt % or less of Mn, 0.0060 wt % or less of N, 0.005 wt % or less of C, and 0.0055 wt % or less of S, a balance of Fe and unavoidable impurities. In an exemplary embodiment of the present invention, the effects are exhibited by the thickness of the metal oxide layer 20 and the ratio (DW_{L}/DW_{S}) of average magnetic domain widths, independent of alloy components of the grain oriented electrical steel sheet base material 10, and as the grain oriented electrical steel sheet base material 10, a grain oriented electrical steel sheet base material 10 that is usually used can be used without limitation. Below, the alloy components of the grain oriented electrical steel sheet base material 10 will be supplementally described.

### Si: 2.5 to 4.0 wt %

Silicon (Si) is an elemental composition of the electrical steel sheet, which functions to lower the iron loss (core loss) by increasing the specific resistance of the material. If the Si content is too low, the specific resistance decreases, the eddy current loss increases, and thus the iron loss characteristics deteriorate. Further, during secondary recrystallization annealing, phase transformation occurs between ferrite and austenite, so that the secondary recrystallization may become unstable, as well as the texture may be severely damaged. On the other hand, if the Si content is too high, it may be difficult to perform cold rolling. Therefore, Si may be included in an amount of 2.5 to 4.0 wt %. More specifically, Si may be included in an amount of 2.3 to 3.7 wt %.

### Al: 0.020 to 0.040 wt %

Aluminum (Al) is precipitated in the form of fine AlN during hot rolling and hot-rolled sheet annealing. Al also forms nitride in the form of (Al,Si,Mn)N or AlN in which nitrogen ion, which is introduced by ammonia gas during the primary recrystallization annealing process after the cold rolling, is combined with Al, Si, and Mn, which are dissolved in the steel. These serve as a strong grain growth inhibitor. If the Al content is too low, the inhibiting ability is weak, and if the Al content is too high, the coarse nitride is formed to deteriorate the grain growth inhibiting ability. Therefore, the Al content is controlled to 0.02 to 0.04 wt %. More specifically, Al may be included in an amount of 0.025 to 0.035 wt %.

### Mn: 0.20 wt % or Less

Manganese (Mn) is an important element because Mn has, like Si, the effect of increasing the specific resistance to decrease the eddy current loss, thereby reducing the total iron loss, and Mn reacts with nitrogen introduced by a nitriding treatment together with Si to form precipitates of (Al,Si,Mn)N and (Mn,Cu)S, thereby inhibiting growth of the primary recrystallized grain to cause the secondary recrystallization. However, if Mn is excessively included, a large amount of Mn oxide is formed to cause phase transformation between ferrite and austenite during the secondary recrystallization annealing process, so the texture may be severely damaged and the magnetic properties may be significantly deteriorated. Therefore, Mn may be included in an amount of 0.20 wt % or less. More specifically, Mn may be included in an amount of 0.15 wt % or less.

### N: 0.0060 wt % or Less

Nitrogen (N) is an important element that reacts with Al and Si to form (Al,Si,Mn)N, and may be included in an amount of 0.0060 wt % or less in a slab. If the N content is too high, the nitrogen diffusion causes surface defects, which are called blisters, in the process after the hot rolling. Further, nitrides are formed too much in a slab state, so the rolling is difficult and the subsequent process is complicated, causing an increase in the production cost. Note that N that is further necessary for forming nitrides such as (Al,Si Mn)N may be supplemented by a nitriding treatment for the steel using ammonia gas in the annealing process after cold rolling. In addition, since some N is removed during the secondary recrystallization process, N may be included in an amount of 0.0060 wt % or less in the finally manufactured grain oriented electrical steel sheet.

### C: 0.005 wt % or Less

Carbon (C) is an element that contributes to refining grains and improving elongation by causing phase transformation between ferrite and austenite, and is an essential element for enhancing the rolling properties of an electrical steel sheet having poor rolling properties due to high brittleness. However, C is an element that precipitates a carbide, which is formed by a magnetic aging effect, in a product sheet and deteriorates the magnetic properties when C remains in the finally manufactured grain oriented electrical steel sheet 10. Thus, C may be controlled to an appropriate content. C may be included in an amount of 0.04 to 0.07 wt % in a slab. If the C content is too low, the phase transformation between ferrite and austenite does not adequately occur, resulting in non-uniformity of the microstructure of the slab and hot-rolled sheet. On the other hand, if the C content is too high, sufficient decarburization cannot be obtained during the primary recrystallization annealing, the phase transformation phenomenon caused due to the insufficient decarburization severely damages the secondary recrystallization texture, and furthermore, deterioration of magnetic properties due to magnetic aging is caused when the final product is applied to electric power equipment. Therefore, C may be included in an amount of 0.04 to 0.07 wt % in a slab. Note that since C is removed through the above-described decarburization, C may be included in an amount of 0.005 wt % or less in the finally manufactured grain oriented electrical steel sheet base material 10.

### S: 0.0055 wt % or Less

If the sulfur(S) content is too high, precipitates of MnS are formed in the slab to inhibit the grain growth. Further, the precipitates may be segregated at the center of the slab during the casting, so that it is difficult to control the microstructure in the subsequent process. In addition, since MnS is not used as a grain growth inhibitor in the present invention, it is not desirable to add more than the inevitable amount of S, causing precipitation. Therefore, the S content may be controlled to 0.0055 wt % or less. More specifically, S may be included 0 in an amount of 0.0050 wt % or less.

The grain oriented electrical steel sheet base material may further include one or more of 0.02 to 0.075 wt % of P and 0.05 to 0.35 wt % of Cr.

### P: 0.02 to 0.075 wt %

Phosphorus (P) is segregated at grain boundaries to hinder movement of the grain boundaries and at the same time can play an auxiliary role of inhibiting the grain growth. In addition, P has an effect of improving a {110}<001> texture in terms of the microstructure. If the P content is too low, there is no effect of addition, and if the P content is too high, brittleness may increase and the rolling properties may significantly deteriorate. Therefore, P may be included in an amount of 0.02 to 0.075 wt % when further included. More specifically, P may be included in an amount of 0.025 to 0.05 wt %.

### Cr: 0.05 to 0.35 wt %

Chromium (Cr) reduces eddy current loss by increasing the specific resistance, and at the same time promotes oxidation during the decarburization and nitriding process, thereby improving subsequent coating adhesiveness. If the Cr content is too low, the effect of addition is low, and if the Cr content is too high, the magnetic flux density deteriorates, and nitriding and purification annealing is suppressed. Therefore, Cr may be included in an amount of 0.05 to 0.035 wt % when further included. More specifically, Cr may be included in an amount of 0.10 to 0.25 wt %.

In addition to the above components, the present invention includes Fe and inevitable impurities. In addition to the above components, addition of effective components is not excluded. If additional components are included, they are included in place of the balance of Fe.

As shown in FIG. 2, the grain oriented electrical steel sheet 100 according to an exemplary embodiment of the present invention may further include an insulating coating 30 present on the metal oxide layer 20.

Since the insulating coating 30 is widely known, detailed description thereof will be omitted. Specifically, the insulating coating 30 containing silica as a main component may be present. More specifically, the insulating coating 30 containing silica and metal phosphate may be present.

The heat-affected zone 40 may be present in only one of one side and the other side of the electrical steel sheet 100. The heat-affected zone 40 may be formed by irradiating laser, plasma, or an electron beam. More specifically, the heat-affected zone 40 may be formed by irradiating laser.

As shown in FIGS. 1 and 2, the heat-affected zone 40 may be present across the electrical steel sheet base material 10, the metal oxide layer 20, and the insulating coating 30 when the insulating coating 30 is present. The electrical steel sheet base material 10 with the heat-affected zone 40 can be distinguished from another electrical steel sheet base material 10 without the heat-affected zone 40 by utilizing a Kerr microscope to identify a region that has an irregular arrangement of magnetic domains.

The heat-affected zone 40 in the metal oxide layer 20 can be distinguished by identifying a damaged portion of the metal oxide layer using a scanning electron microscope.

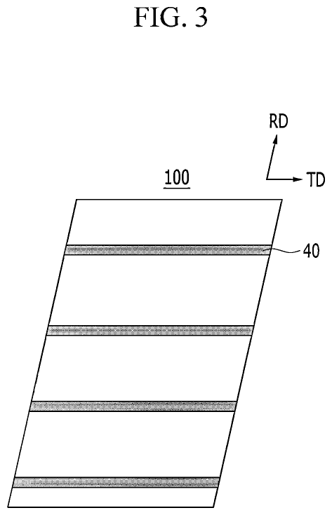

FIG. 3 schematically shows a shape of the heat-affected zone 40. As shown in FIG. 3, the heat-affected zone 40 may be present in the shape of a line extending in a direction intersecting the rolling direction. More specifically, the heat-affected zone 40 may form an angle of 85° to 90° with the rolling direction.

As shown in FIG. 3, the heat-affected zone 40 may be present in plural, and an average spacing between the heat-affected zones in the rolling direction may be 3 to 7 mm. By adjusting the spacing of the heat-affected zones 40, iron loss can be further improved.

A width of the heat-affected zone 40 in the rolling direction may be 50 to 500 μm, and a depth in the electrical steel sheet base material 10 may be 10 to 200 μm.

In an exemplary embodiment of the present invention, the grain oriented electrical steel sheet may have an iron loss (W17/50) of 0.85 W/kg or less and an excitation power of 2.0 VA/kg. More specifically, the iron loss (W17/50) may be 0.83 W/kg or less, and the excitation power may be 1.8 VA/kg or less.

A method for manufacturing a grain oriented electrical steel sheet according to an exemplary embodiment of the present invention includes manufacturing a hot-rolled steel sheet by hot-rolling a slab; manufacturing a cold-rolled steel sheet by cold-rolling the hot-rolled steel sheet; subjecting the cold-rolled steel sheet to primary recrystallization annealing; subjecting the primary recrystallization annealed steel sheet to secondary recrystallization annealing; and performing a magnetic domain refining treatment on one side of the secondary recrystallization annealed steel sheet.

Below, each process will be described in detail.

First, a slab is hot rolled to manufacture a hot-rolled sheet. Since the alloy components of the slab have been described regarding the grain oriented electrical steel sheet base material 10, redundant description will be omitted. The alloy components of the slab are substantially the same as those of the grain oriented electrical steel sheet base material 10, except for the C content.

The slab may be heated before hot rolling. When heating the slab, the heating may be performed within a predetermined temperature range where N and S to be dissolved become incompletely solubilized. When N and S are completely solubilized, nitrides or sulfides are finely formed in a large amount after hot-rolled steel sheet annealing heat treatment, which makes subsequent cold rolling difficult. In addition, the size of primary-recrystallized grains become significantly fine, so that appropriate secondary-recrystallized grains may not appear. That is, the size and amount of additional AlN formed in the decarburizing and nitriding annealing process depend on N to be re-dissolved, and in the case that the size of AlN is identical, if the amount is too large, grain growth inhibiting force is increased, so that appropriate secondary recrystallization microstructure consisting of Goss texture may not be obtained. On the other hand, if the amount is too small, grain growth driving force of the primary recrystallization microstructure is increased, so that appropriate secondary recrystallization microstructure may not be obtained, similarly to the above phenomenon. The content of N to be re-dissolved in the annealed steel by slab heating may be 20 to 50 ppm. For the content of N to be re-dissolved, the content of Al contained in the annealed steel should be considered, because the nitrides used as a grain growth inhibitor are (Al,Si,Mn)N and AlN.

When the slab is heated beyond 1280° C., Fayalite, a compound of low melting silicon and base metal iron, is generated on the steel plate, while the surface of the steel plate is melted down, and thus, hot rolling workability becomes very difficult, and heating furnace repair due to melted iron is increased. It is preferred to heat the slab to a temperature of 1250° C. or lower for incomplete solubilization capable of the above-described reason, that is, heating furnace repair and appropriate control of cold rolling and primary recrystallization texture.

In the hot-rolled steel sheet, modified texture stretched by stress in a rolling direction is present, and AlN, (Mn,Cu)S or the like is precipitated during hot rolling. Therefore, in order to have uniform recrystallization microstructure and fine precipitate distribution before cold rolling, it is required that the hot rolled steel sheet is once again heated to slab heating temperature or less, thereby recrystallizing the modified structure, and in addition, that a sufficient austenite phase is secured to promote dissolution of the grain growth inhibitor of the precipitates. Therefore, after hot rolling, a hot rolled steel sheet annealing step of annealing the hot rolled steel sheet may be further included. Regarding the hot-rolled steel sheet annealing temperature, heating to 900 to 1200° C. is performed for a maximum austenite fraction, and then soaking heat treatment and cooling may be performed. After annealing the hot-rolled steel sheet, the average size of the precipitates in the hot-rolled steel sheet may range from 200 to 3000 Å.

Next, the hot-rolled steel sheet is cold-rolled to manufacture a cold-rolled steel sheet.

In the cold rolling step, cold rolling to a thickness of 0.10 mm to 0.50 mm is carried out using a reverse roller or tandem roller, and single strong cold rolling where rolling is carried out at an initial hot rolled thickness directly to a thickness of the final product without annealing heat treatment of modified structure in the middle, may be carried out. With the single strong cold rolling, the orientations having a low integration degree of {110}<001> orientation are rotated to a modified orientation, and only the Goss grains well oriented to the {110}<001> orientation remain in the cold-rolled steel sheet. Therefore, in a method in which rolling is carried out two or more times, the orientations having a low integration degree are also present in the cold-rolled steel sheet, and secondary recrystallization is carried out upon secondary recrystallization annealing, thereby deteriorating magnetic flux density and iron loss. Therefore, cold rolling may be carried out by single strong cold rolling. More specifically, cold rolling may be carried out at a cold rolling rate of 87 wt % or more.

Next, the cold-rolled steel sheet is subjected to primary recrystallization annealing.

Decarburization and nitriding may occur during the primary recrystallization annealing process. First, nitriding will be described. Nitriding may be performed by introducing nitriding gas as an atmosphere gas during the primary recrystallization annealing process. The nitriding gas may include ammonia gas. Introducing nitrogen ions to the steel sheet through nitriding may be helpful in precipitating inhibitors such as (Al,Si,Mn)N and AlN.

Regarding decarburization and nitriding, nitriding may be performed after decarburization, decarburization may be performed after nitriding, or nitriding and decarburization may be performed simultaneously.

Decarburization can be performed by adjusting the dew point in the atmosphere to 69.0 to 72.5° C. The higher the dew point temperature, the more efficient decarburization. However, in an exemplary embodiment of the present invention, the dew point can be adjusted within the range described above in relation to the magnetic domain refinement treatment described below. If the dew point temperature is too low, the metal oxide layer 20 may not be formed properly. From the standpoint of forming the metal oxide layer 20, the higher the dew point temperature, the more advantageous. However, in this case, surface defects and deterioration in magnetic properties may appear as the metal oxide layer falls off due to reduced adhesiveness, so it is necessary to appropriately adjust the upper limit of the dew point temperature. More specifically, the dew point temperature may be adjusted to 69.5 to 71.5° C.

The primary recrystallization annealing temperature may be 800 to 950° C. If the annealing temperature of the steel sheet is too low, decarburization and nitriding take a long time, making it difficult to properly form the metal oxide layer 20. temperature is too high, the primary-recrystallized grains grow coarsely and the grain growth driving force decreases, so that stable secondary-recrystallized grains may not be formed. Although the annealing time is not a big problem for showing the effects of the present invention, the annealing treatment may be performed for 5 minutes or less, considering productivity.

After the primary recrystallization annealing, the steel sheet may have an oxygen content of 800 to 1100 ppm. The oxygen content can be adjusted according to the dew point temperature, annealing temperature, and time during the primary recrystallization annealing. In this case, the amount of oxygen is measured by cutting the steel plate into 3 mm×3 mm and melting the entire cut steel sheet. Accordingly, the amount of oxygen refers to an average content relative to the entire steel sheet. The amount of oxygen can be adjusted according to the dew point temperature, annealing temperature, and time during the primary recrystallization annealing. More specifically, the amount of oxygen may be 820 to 1070 ppm.

A step of applying an annealing separator to the steel sheet subjected to the primary recrystallization annealing may be further included. For the annealing separator, any generally known annealing separator may be used without limitation. During the secondary recrystallization annealing process, the steel sheet is annealed for a long time in a coil form, and an annealing separator is applied to prevent the coiled steel sheet from joining during this process. The components of the annealing separator combine with oxygen and Si of the oxide layer to form the metal oxide layer 20. Specifically, as the annealing separator, an annealing separator containing one or more of magnesium oxide, aluminum oxide, and manganese oxide may be used. More specifically, an annealing separator containing MgO may be used.

Next, the steel sheet subjected to the primary recrystallization annealing is subjected to secondary recrystallization annealing. During the secondary recrystallization annealing process, a {110}<001> texture is formed in which the {110} plane of the steel sheet is parallel to the rolling surface and the <001> direction is parallel to the rolling direction, resulting in the manufacture of a grain oriented electrical steel sheet with excellent magnetic properties. Broadly speaking, the secondary recrystallization annealing is to form a {110}<001> texture by secondary recrystallization, to provide insulation by forming the metal oxide layer 20 resulting from the reaction of the oxide layer formed during the primary recrystallization annealing process with the annealing separator, and to remove impurities that damage magnetic properties. During the secondary recrystallization annealing, in the temperature rising section before the secondary recrystallization occurs, a mixed gas of nitrogen and hydrogen is maintained to protect nitride, which is a grain growth inhibitor, so the secondary recrystallization develops well, and after the completion of the secondary recrystallization, it is maintained for a long time in a 100 wt % hydrogen atmosphere to remove impurities.

After the secondary recrystallization annealing, an insulating coating composition can be applied to form an insulating coating. During this process, flattening annealing may be performed to correct the sheet shape. The insulating coating composition is not particularly limited, and an insulating coating composition containing silica may be used. Alternatively, an insulating coating composition containing silica and metal phosphate may be used.

Next, magnetic domain refinement treatment is performed on one side of the steel sheet subjected to the secondary recrystallization annealing. The magnetic domain refinement treatment method is not particularly limited, but in an exemplary embodiment of the present invention, the magnetic domain refinement treatment may be performed by forming the heat-affected zone 40 rather than forming a recess or groove. The method of forming the heat-affected zone 40 is not particularly limited, and the heat-affected zone 40 may be formed by irradiating laser, plasma, or an electron beam. More specifically, laser may be irradiated.

In an exemplary embodiment of the present invention, by appropriately adjusting the input energy during the magnetic domain refinement process, iron loss and excitation power can be improved at the same time. The input energy may be 6.5 to 10 J/m. In this case, the input energy refers to a value obtained by dividing the laser energy applied to the steel sheet by the length of the laser irradiation line (the length of the steel sheet width when irradiated across the entire width of the steel sheet). That is, the input energy refers to a value obtained by dividing the total energy forming one heat-affected zone 40 by the length of the heat-affected zone 40. If the input energy is too small, it is difficult to obtain a sufficient magnetic domain refinement effect. If the input energy is too great, the heat-affected zone 20 may be formed in a large amount, resulting in deterioration of excitation power and permeability. More specifically, the input energy is 7 to 9 J/m.

The input energy can be adjusted in conjunction with the amount of oxygen in the oxide layer formed after the primary recrystallization annealing. That is, when the amount of oxygen in the oxide layer is small, a sufficient magnetic domain refinement effect can be obtained even by lowering the input energy. On the contrary, if the amount of oxygen in the oxide layer is large, a sufficient magnetic domain refinement effect can be obtained only by increasing the input energy, and conversely, even if the input energy is increased, the excitation power and the permeability are affected relatively little. More specifically, a relationship between the oxygen content in the oxide layer and the input energy can satisfy Formula 2 below.

35.8×oxygen content (wt %)+2.5≤input energy (J/m)≤35.8×oxygen content (wt %)+7 [Formula 2]

The magnetic domain refinement treatment may be performed on only one side of the steel sheet, and the other side may not be subjected to the magnetic domain refinement treatment.

Since the shape of the heat-affected zone 20 during the magnetic domain refinement process has been described with respect to the heat-affected zone 20 described above, redundant descriptions will be omitted. That is, when irradiating laser, plasma, or electron beam, the irradiation is performed in a line shape extending in the intersecting direction, and the average interval may be 3 to 7 mm.

For example, in the case of irradiating laser to the steel sheet, a beam length of the laser in a direction perpendicular to a steel sheet rolling direction may be 5 to 15 mm, and a beam width in the steel sheet rolling direction may be 10 to 200 μm.

Below, the present invention will be described in more detail with reference to examples. However, these examples are only for illustrating the present invention, and the present invention is not limited thereto.

### Experimental Example 1

The steel components including 3.5 wt % of Si, 0.06 wt % of C, 0.12 wt % of Mn, 0.0045 wt % of S, 0.0050 wt % of N, 0.03 wt % of Al, 0.03 wt % of P, and 0.11 wt % of Cr, and including the balance of Fe and other unavoidable impurities were vacuum melted to make an ingot, which was then heated to a temperature of 1150° C. and hot rolled to a thickness of 2.6 mm. The hot-rolled steel sheet was heated to a temperature of 1100° C., held at 950° C. for 180 seconds, and rapidly cooled in water. The hot-rolled annealed steel sheet was pickled and then strongly cold-rolled once to a thickness of 0.27 mm, and the cold-rolled steel sheet was maintained under a mixed gas atmosphere of humid hydrogen, nitrogen, and ammonia at a temperature of 870° C. for 180 seconds to perform simultaneous decarburization and nitriding annealing heat treatments so that a content of nitrogen was 200 ppm. In this process, the average oxygen content in the steel sheet was varied by adjusting the dew point of the atmosphere. This is summarized in Table 1.

MgO, an annealing separator, was applied to the steel sheet, which was then subjected to secondary recrystallization annealing. The secondary recrystallization annealing was performed in a mixed atmosphere of 25 v wt % of nitrogen and 75 v wt % of hydrogen up to 1200° C., and after reaching 1200° C., the steel sheet was maintained in a 100 v wt % hydrogen atmosphere for 10 hours or longer and then cooled in a furnace. Thereafter, an insulating coating composition containing silica as a main component was applied and then heat treated to form an insulating coating.

Magnetic domain refinement was performed while adjusting the input energy using a laser magnetic domain refinement device.

The iron loss and excitation power were measured at an applied magnetic field of 1.7 T and a frequency of 50 Hz using a veneer magnetometer, and a Bitter method was used to photograph magnetic domain patterns on irradiated and non-irradiated surfaces and obtain an average magnetic domain width. The results are summarized in Table 1 below.

TABLE 1

| | | | Maximum | Metal | | | | | |
|---|---|---|---|---|---|---|---|---|---|
| | | | Al fraction | oxide | Magnetic | | Excitation | | |
| Dew | Oxygen | Input | (wt %) in | layer | domain | Iron loss | power | | |
| point | content | energy | metal oxide | thickness | width ratio | (W17/50, | (Ss 17/50, | | |
| (° C.) | (ppm) | (J/m) | layer | (μm) | (DW_{L}/DW_{S}) | W/kg) | VA/kg) | Remarks | [symbol] |
| 70.2 | 858 | 6 | 0.83 | 2.0 | 2.10 | 0.901 | 1.53 | Comparative Material 1 | [symbol] |
| 70.0 | 837 | 7 | 0.89 | 1.9 | 1.75 | 0.838 | 1.63 | Inventive Material 1 | [symbol] |
| 70.0 | 831 | 8 | 0.91 | 1.9 | 1.60 | 0.823 | 1.70 | Inventive Material 2 | [symbol] |
| 69.8 | 822 | 9 | 0.94 | 1.7 | 1.30 | 0.817 | 1.77 | Inventive Material 3 | [symbol] |
| 70.0 | 846 | 11 | 0.86 | 1.8 | 1.00 | 0.833 | 2.32 | Comparative Material 2 | [symbol] |
| 70.8 | 924 | 6 | 0.61 | 2.6 | 2.00 | 0.872 | 1.63 | Comparative Material 3 | [symbol] |
| 71.0 | 947 | 8 | 0.57 | 2.7 | 1.70 | 0.827 | 1.58 | Inventive Material 4 | [symbol] |
| 71.0 | 949 | 9 | 0.55 | 2.6 | 1.60 | 0.823 | 1.71 | Inventive Material 5 | [symbol] |
| 71.1 | 955 | 10 | 0.54 | 2.7 | 1.25 | 0.812 | 1.78 | Inventive Material 6 | [symbol] |
| 71.2 | 974 | 11 | 0.49 | 2.9 | 1.05 | 0.809 | 2.12 | Comparative Material 4 | [symbol] |
| 71.0 | 931 | 12 | 0.61 | 2.5 | 1.00 | 0.811 | 2.34 | Comparative Material 5 | [symbol] |
| 72.0 | 1056 | 6 | 0.23 | 3.2 | 2.10 | 0.912 | 1.53 | Comparative Material 6 | [symbol] |
| 72.2 | 1069 | 8 | 0.19 | 3.6 | 1.78 | 0.823 | 1.69 | Inventive Material 7 | [symbol] |
| 72.2 | 1068 | 9 | 0.2 | 3.7 | 1.60 | 0.815 | 1.66 | Inventive Material 8 | [symbol] |
| 72.2 | 1055 | 10 | 0.25 | 3.6 | 1.30 | 0.808 | 1.75 | Inventive Material 9 | [symbol] |
| 72.0 | 1028 | 11 | 0.35 | 3.1 | 1.01 | 0.803 | 2.24 | Comparative Material 7 | [symbol] |
| 72.0 | 1059 | 12 | 0.23 | 3.3 | 1.05 | 0.811 | 2.47 | Comparative Material 8 | [symbol] |
| 68.8 | 750 | 8 | 1.3 | 1.1 | 1.00 | 0.901 | 2.20 | Comparative Material 9 | [symbol] |
| 73.0 | 1150 | 9 | 0.05 | 4.4 | 2.10 | 0.904 | 2.30 | Comparative Material 10 | [symbol] |

[symbol]

indicates data missing or illegible when filed

As shown in Table 1, the inventive materials where the input energy and the dew point were appropriately adjusted during the primary recrystallization annealing process have the magnetic domain width ratio (DWLDWS) properly adjusted, so it can be confirmed that both iron loss and excitation power are excellent at the same time.

On the other hand, it can be confirmed that Comparative Materials 1, 3, and 6 where the input energy is too small have too large magnetic domain width ratios and appropriate iron loss cannot be obtained. On the other hand, in Comparative Materials 2, 4, 5, 7, and 8 where the input energy is too large, it can be confirmed that magnetic domain width ratios are too small and the excitation power is inferior. In the case of Comparative Materials 9 and 10, it can be confirmed that the oxidation amount is too high or low, so the metal oxide layer is not properly formed thereafter, the growth of secondary recrystallized grains is not smooth, the surface defects are excessively formed, and therefore, even if the input energy is appropriately adjusted, the iron loss or excitation power is also inferior.

It will be understood by one skilled in the art to which the present invention belongs that the present invention is not limited to the above exemplary embodiments, but can be manufactured in a variety of different forms, and can be implemented in other specific forms without changing the technical spirit or essential features of the present invention. Therefore, the exemplary embodiments described above should be understood as illustrative in all respects and not for purposes of limitation.

### EXPLANATION OF REFERENCE NUMERALS AND SYMBOLS

10: grain oriented electrical steel sheet base material,
20: metal oxide layer, 30: insulating coating,
40: heat-affected zone,
100: grain oriented electrical steel sheet

1. A grain oriented electrical steel sheet comprising:
a grain oriented electrical steel sheet base material; and
a metal oxide layer present on both sides of the grain oriented electrical steel sheet base material,
wherein a maximum Al fraction in the metal oxide layer is 0.15 to 1.0 wt %, and
wherein a ratio (DW_{L}/DW_{S}) of an average magnetic domain width (DW_{L}) of a side with a large average magnetic domain width to an average magnetic domain width (DW_{S}) of a side with a small average magnetic domain width of one side and the other side of the electrical steel sheet base material is 1.2 to 1.8.

2. The grain oriented electrical steel sheet of claim 1, wherein
a thickness of the metal oxide layer is 1.5 μm to 4 μm.

3. The grain oriented electrical steel sheet of claim 1, wherein
the grain oriented electrical steel sheet base material comprises 2.5 to 4.0 wt % of Si, 0.020 to 0.040 wt % of Al, 0.20 wt % or less of Mn, 0.0060 wt % or less of N, 0.005 wt % or less of C, and 0.0055 wt % or less of S, a balance of Fe, and unavoidable impurities.

4. The grain oriented electrical steel sheet of claim 1, wherein
the grain oriented electrical steel sheet base material further comprises one or more of 0.02 to 0.075 wt % of P and 0.05 to 0.35 wt % of Cr.

5. The grain oriented electrical steel sheet of claim 1, wherein
the grain oriented electrical steel sheet further comprises an insulating coating present on the metal oxide layer.

6. The grain oriented electrical steel sheet of claim 1, wherein
a relationship between the maximum Al fraction in the metal oxide layer and the magnetic domain width ratio (DW_{L}/DW_{S}) satisfies Formula 1 below.
$$0.23 \times {C}_{Al , Max} + 1. \leq {DW}_{L} / {DW}_{S} \leq 0.23 \times {C}_{Al , Max} + 1.8 \qquad [ Formula 1 ]$$
(in Formula 1, C_{Al, Max} refers to the maximum Al fraction (wt %) in the metal oxide layer.

7. The grain oriented electrical steel sheet of claim 1, wherein
a heat-affected zone is present in only one of one side and the other side of the electrical steel sheet.

8. The grain oriented electrical steel sheet of claim 7, wherein
the heat-affected zone has a line shape extending in a direction intersecting a rolling direction.

9. The grain oriented electrical steel sheet of claim 7, wherein
the heat-affected zone is present in plural, and an average spacing between the heat-affected zones is 3 to 7 mm.

10. A method for manufacturing a grain oriented electrical steel sheet comprising:
manufacturing a hot-rolled steel sheet by hot-rolling a slab;
manufacturing a cold-rolled steel sheet by cold-rolling the hot-rolled steel sheet;
subjecting the cold-rolled steel sheet to primary recrystallization annealing;
subjecting the primary recrystallization annealed steel sheet to secondary recrystallization annealing; and
performing a magnetic domain refinement treatment on one side of the secondary recrystallization annealed steel sheet,
wherein, in the primary recrystallization annealing, a dew point of an atmosphere is 69 to 72.5° C., and
wherein, in the magnetic domain refinement treatment, an input energy is 6.5 to 10 J/m.

11. The method of claim 10, wherein
the primary recrystallization annealed steel sheet has an oxygen content of 800 to 1100 ppm.

12. The method of claim 10, wherein
the oxygen content in the primary recrystallization annealed steel sheet and the input energy satisfy Formula 2 below.
$$35.8 \times oxygen content ( wt \% ) + 2.5 \leq input energy ( J / m ) \leq 35.8 \times oxygen content ( wt \% ) + 7 \qquad [ Formula 2 ]$$

13. The method of claim 10, wherein
in the magnetic domain refinement treatment, laser is irradiated to the steel sheet, a beam length of the laser in a direction perpendicular to a steel sheet rolling direction is 5 to 15 mm, and a beam width in the steel sheet rolling direction is 10 to 200 μm.
